(19) United States
(12) Patent Application Publication
(10) Pub. No.: US 2026/0016654 A1
(43) Pub. Date: Jan. 15, 2026

(54) LENS ASSEMBLY AND DISPLAY DEVICE

(71) Applicants: Asphetek Solutin (Chengdu) Ltd., Chengdu (CN); Asphetek Solution Inc., Hsinchu (TW)

(72) Inventors: CHENG-HONG JIANG, Hsinchu (TW); YEN-HENG HUANG, Hsinchu (TW); HSIAO-CHIEN CHEN, Hsinchu (TW); CHUNG-CHIAO HO, Hsinchu (TW)

(21) Appl. No.: 19/006,614

(22) Filed: Dec. 31, 2024

(30) Foreign Application Priority Data
Jul. 12, 2024 (CN) 202421653972.6

(51) Int. Cl. G02B 7/02

(52) U.S. Cl. CPC G02B 7/022

(57) ABSTRACT

The present application provides lens assembly and display device. The lens assembly includes a lens, a film and a plurality of position structures. The lens defines a bonding surface. The film is bonded on the bonding surface, the film defines a first optical axis. each of the plurality of position structures comprises a position bump and a position incision, one of the position bump and the position incision is arranged at the bonding surface, other of the position bump and the position incision is arranged at edge of the film, a part of the position bump is received in the position incision, two of the plurality of position structures defines a first virtual connection line, an angle between the first virtual connection line and the first optical axis is equal to a preset angle.

### FIELD

The present application relates to the field of display technology, and specifically to lens assembly and display device.

### BACKGROUND

Some lens assembly includes lens and a film bonded on the lens, the film defines an optical axis, the position of the optical axis cannot be located directly with eye, and the position of optical axis of the lens assembly cannot be located directly with eye. In subsequent productions or assembly processes of the lens assembly, expensive testing equipment is needed to determine the position of the optical axis of the lens assembly, which makes the processing and the production cost of the lens assembly high.

### BRIEF DESCRIPTION OF THE DRAWINGS

FIG. 1 shows a schematic view of a structure of a display device in an embodiment according to the present disclosure.

FIG. 2 shows a schematic view of a structure of a lens assembly in an embodiment according to the present disclosure.

FIG. 3 shows a partial enlarged view of a portion of the lends assembly marked III in FIG. 2.

FIG. 4 shows a top view of the lens assembly as shown in FIG. 2.

FIG. 5 shows a partial enlarged view of a portion of the lens assembly marked V in FIG. 4.

FIG. 6 shows a partial view of a structure of the lens assembly in FIG. 4.

FIG. 7 shows a schematic view of a lens assembly in another embodiment according to the present disclosure.

FIG. 8 shows a top view of a lens assembly in yet another embodiment according to the present disclosure.

FIG. 9 shows a top view of a lens assembly in yet another embodiment according to the present disclosure.

FIG. 10 shows a top view of a lens assembly in yet another embodiment according to the present disclosure.

FIG. 11 shows a schematic view of a lens assembly in yet another embodiment according to the present disclosure.

FIG. 12 shows a partial enlarged view of a portion of the lens assembly marked XII in FIG. 11.

FIG. 13 shows a top view of the lens assembly in FIG. 11.

FIG. 14 shows a schematic diagram of the lens assembly in FIG. 11.

### DETAILED DESCRIPTION

The technical solutions in the embodiments of the present application will be described clearly and completely in the following in conjunction with the accompanying drawings in the embodiments of the present application, and it is clear that the described embodiments are only a part of the embodiments of the present application and not all of the embodiments.

It should be noted that when an element is the to be “fixed” to another element, it may be directly on the other element or there may also be a centered element. When an element is the to be “attached” to another element, it may be directly attached to the other element or there may be both centered elements. When an element is considered to be “set on” another element, it may be set directly on the other element or there may be both centered elements. The terms “vertical,” “horizontal,” “left,” “right,” and similar expressions are used herein for illustrative purposes only. are used herein for illustrative purposes only.

Unless otherwise defined, all technical and scientific terms used herein have the same meaning as commonly understood by those skilled in the art belonging to the field of this application. Terms used herein in the specification of this application are used only for the purpose of describing specific embodiments and are not intended to limit this application. The term “or/and” as used herein includes any and all combinations of one or more related listed items.

Some embodiments of the present application are described in detail. The following embodiments and features in the embodiments may be combined with each other without conflict.

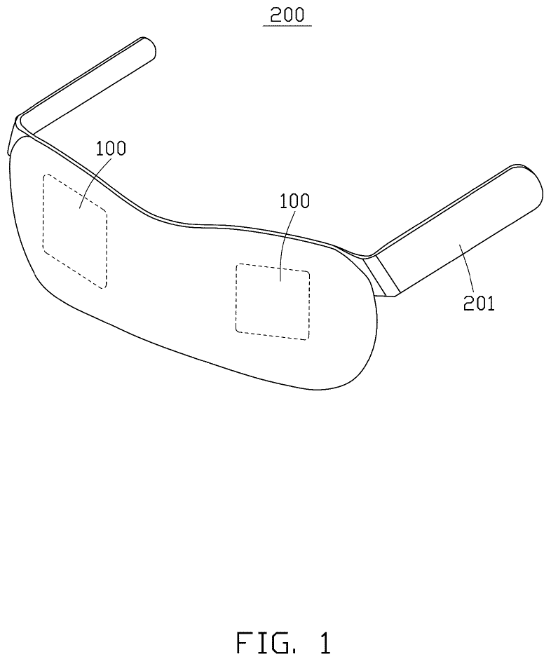

Referring to FIG. 1, in one embodiment, a display device 200 is provided. The display device 200 includes a mounting frame 201 and lens assembly 100. The lens assembly 100 is arranged in the mounting frame 201. The display device 200 is AR (augmented reality) display device, VR (virtual reality) display device, MR (mixed reality) display device or other types of display device.

In one embodiment, the display device 200 is head-mounted display device, and the mounting frame 201 is helmet.

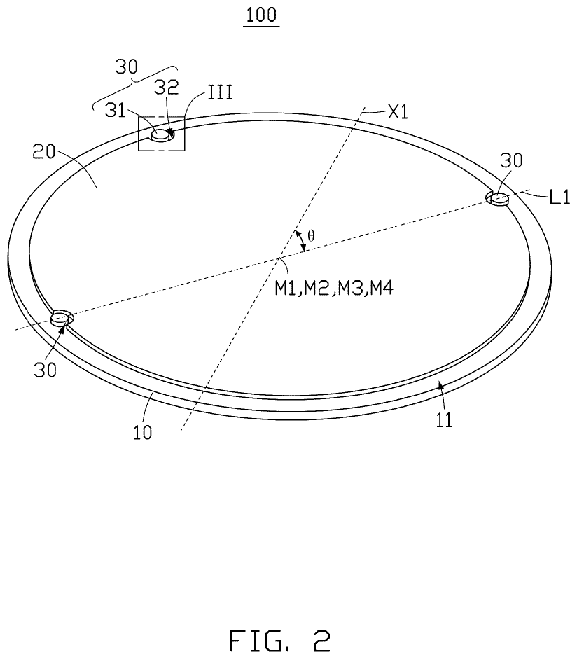

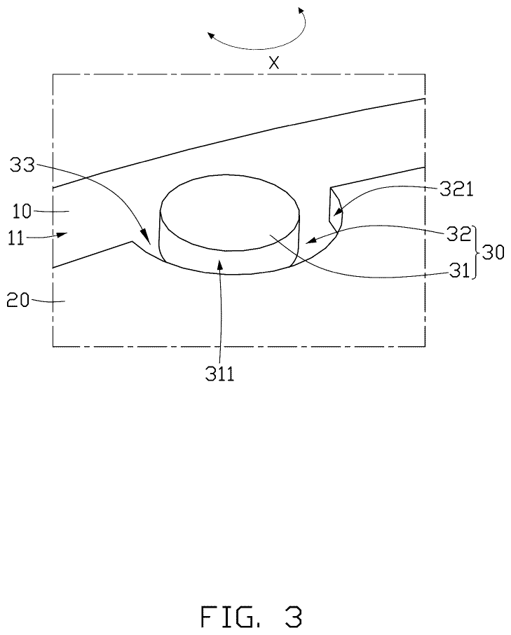

In one embodiment, referring to FIG. 2 and FIG. 3, the lens assembly 100 includes a lens 10, film 20 and a plurality of position structures 30. The lens 10 having a bonding surface 11. The film 20 bonded on the bonding surface 11, the film 20 defines a first optical axis X1. Each of the plurality of position structures 30 comprises a position bump 31 and a position incision 32, one of the position bump 31 or the position incision 32 is arranged on the bonding surface 11, another one of the position bump 31 or the position incision 32 is arranged at edges of the film 20, a part of the position bump 31 is received in the position incision 32, two of the plurality of position structures 30 defines a first virtual connection line L1, an angle θ between the first virtual connection line L1 and the first optical axis X1 is equal to a preset angle α.

In one embodiment, 15°≤α≤345°. The preset angle α may be one of 15°, 45°, 90°, 135°, 180°, 225°, 270°, 315°, 345°.

When assembling the film 20 on the lens 10, bonding the film 20 on the bonding surface 11, respectively matching the position bump 31 and the position incision 32 of each of the plurality of position structures 30, therefore, position information of the optical axis X1 on the film 20 is determined by position information of the two position structures 30, to determine position information of optical axis of the lens assembly 100 after completion of assembly. In subsequent application process of the lens assembly 100 such as to continuing to attach other films, in combination with other lens assembly, or in process of mounting other components, position of optical axis of the lens assembly 100 can be quickly determined by the two position structures 30, without need for expensive optical measuring equipment, thereby reducing cost of subsequent processing and production of the lens assembly 100.

During assembly process of the lens assembly 100, roughly placing the position bump 31 into the position groove 32, and adjusting position of the film 20 on the lens 10. Since a part of the position bump 31 fits into the position groove 32, the position bump 31 and the position groove 32 can maintain non-interference during position adjustment process of the film 20. Therefore, relative motion of film 20 and the lens 10 is easy to realize, and relative position of the film 20 and the lens 10 is easily adjusted manually, this improving matching accuracy of the position bump 31 and the position groove 32, and reducing assembly difficulty between the film 20 and the lens 10, improving fitting accuracy of the film 20 and the lens 10, and improving manual operation convenience, improving assembly accuracy and efficiency of the lens assembly 100. Furthermore, in process of fitting the film 20 to the lens 10, matching the position bumps 31 and the position grooves 32 of multiple position structures 30, that is, there are a plurality of positioning positions between the film 20 and the lens 10, this reducing error of alignment position of the film 20 on the lens 10, and improving assembly accuracy between the film 20 and the lens 10.

Besides, shape of the lens 10 and shape of the film 20 does not limit structural design of the plurality of position structures 30, therefore, shape of the lens assembly 100 can be circle, oval or polygon. The lens assembly 100 can be formed as an equal thickness structure or an unequal thickness structure. The equal thickness structure is one in which thickness of each area is equal to each other.

In one embodiment, the film 20 can be bonded on the lens 10 by roller bonding method or vacuum bonding method.

The known film is obtained by cutting a specify area of an optical film, and direction of optical axis of the known film is the same as direction of optical axis of the optical film. In cutting process of the known film, application of optical equipment to determine direction of optical axis of the optical film is required. Therefore, During the cutting process of the film 20, position of the optical axis X1 of the film 20 can be determined by adding an internal concave shape to cutting path of the film 20 to form a pair of bit notch 32 or position bump 31, and controlling virtual line between two spaced position bumps 31 or position incisions 32 is parallel to the optical axis X1. In this way, after the cutting process of the film 20, position of the optical axis X1 can be determined by the position bumps 31 or the position incisions 32.

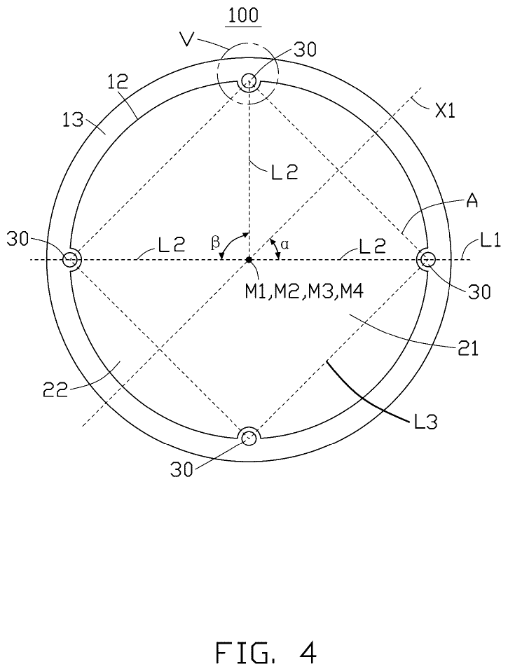

In one embodiment, referring to FIG. 4, the lens 10 defines a first central point M1, the first central point M1 is on an orthographic projection of the first optical axis X1 onto the film 20. Each two adjacent position structures 30 of the plurality of position structures 30 define a boundary virtual connection line L3, a polygonal region A is defined by the boundary virtual connection lines L3 connected to adjacent boundary virtual connection lines L3, the first central point M1 is located inside of the polygonal region A or on the boundary virtual connection line L3. The boundary of the polygon region A is the boundary virtual line L3.

In this way, in process of fitting the film 20 to the lens 10, a plurality of position grooves 32 outside the first central point M1 can be controlled to fit a plurality of position bumps 31, so that several positions on edge of the film 20 can be aligned with the lens 10 through the plurality of structures 30, thereby improving position accuracy of the film 20 relative to the lens 10 after repeated position adjustment, and reducing position error of the optical axis X1.

In one embodiment, referring to FIG. 4, quantity of the plurality of position structures 30 is four. Each of the plurality of position structures 30 and the first central point M1 defines a second virtual connection line L2. An angle β between each two adjacent second virtual connection lines L2 is 90°.

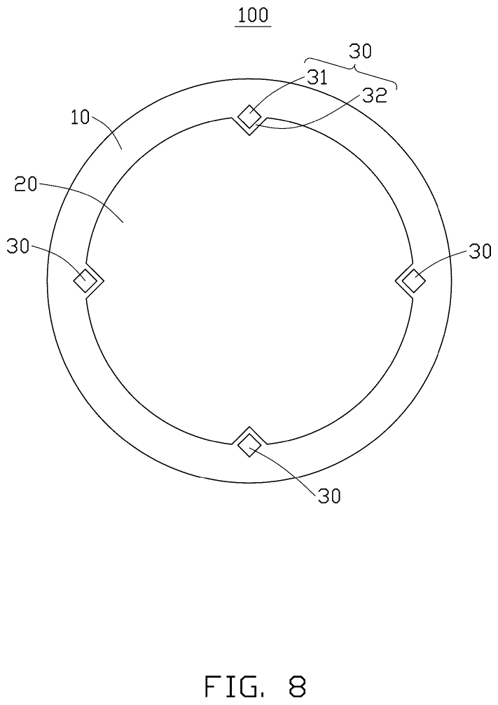

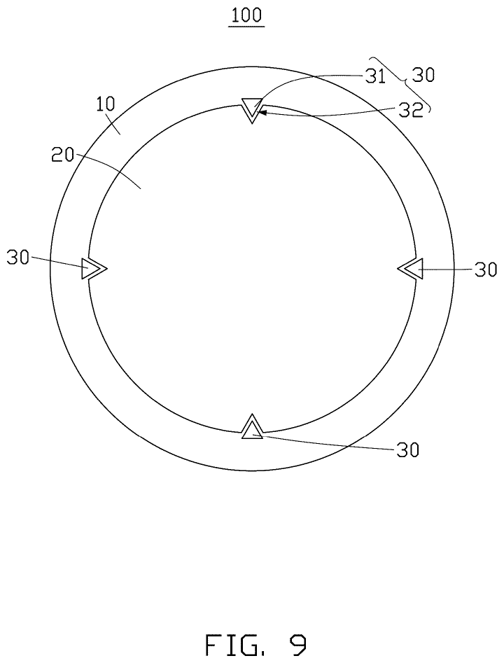

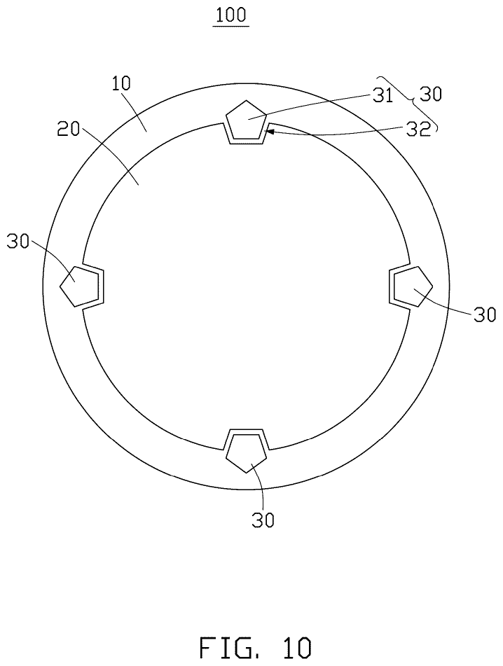

In one embodiment, referring to FIG. 8-10, the plurality of position structures 30 is evenly distributed around the first central point M1, this improving assembly accuracy of the film 20 and the lens 10.

In one embodiment, referring to FIG. 4, a plurality of position bumps 31 is distributed at edge of the lens 10. Connection line between each two adjacent position bumps 31 is the boundary virtual connection line L3, a plurality of boundary virtual connection lines L3 is connected and enclosed to form a polygonal region A.

In one embodiment, referring to FIG. 4, the lens 10 includes an optical part 12 and a connection part 13. The connection part 13 is connected to edge of the optical part 12. The film 20 comprises a transparent part 21 and a cooperating part 22, the cooperating part 22 is connected to edge of the transparent part 21, the transparent part 21 is bonded on the optical part 12. One of the position bump 31 or the position incision 32 is arranged at the connection part 13, another one of the position bump 31 or the position incision 32 is arranged at the cooperating part 22. In this way, the optical part 12 and the light transmission part 21 are keeping intact, and light transmission performance of the lens assembly 100 being not affected by the plurality of position structures 30.

In one embodiment, referring to FIG. 4, cross section of the lens 10 is a first circle, the first circle defines a first center M2, the first center M2 is the first central point M1. In other embodiment, cross section of the lens 10 is ellipse, polygon or special shape, and the first central point M1 is geometric center point of cross section of the lens 10.

In one embodiment, referring to FIG. 4, the film 20 defines a second central point M3. A plurality of position structures 30 includes a first position structure 30 and a second position structure 30. The first virtual connection line L1 is defined between the first position structure 30 and the second position structure 30, the first virtual connection line L1 and the optical axis X1 intersects at the second central point M3, or the first virtual connection line L1 coincides with the optical axis X1. That is, a plurality of position structures 30 defines a plurality of first virtual connection lines L1, and the angle θ between one of the plurality of first virtual connection lines L1 and the optical axis X1 is the preset angle α.

In one embodiment, cross section of the film 20 is a second circle, the second circle defines a second center M4, the second center M4 is the second central point M3. In other embodiment, cross section of the film 20 is ellipse, polygon or special shape, and the second central point M3 is geometric center point of cross section of the film 20.

In one embodiment, the lens 10 can be molded by injection molding or precision CNC machining.

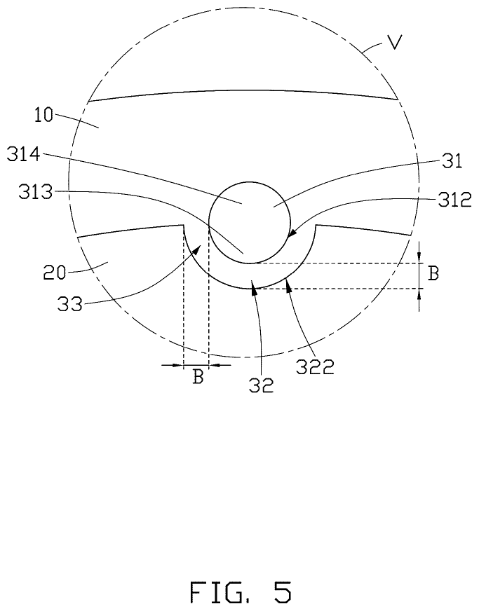

In one embodiment, referring to FIG. 3 and FIG. 5, the position bump 31 defines a first position surface 311, the position incision 32 defines a second position surface 321, the first position surface 311 is spaced apart from the second position surface 321, and define an adjustment space 33, each part of the adjustment space 33 is equal to each other along direction between the first position surface 311 and the second position surface 321. An adjustment space 33 is defined between the first position surface 311 and the second position surface 321. During process of bonding the film 20 on the lens 10, spacing of the plurality of adjustment spaces 33 will change relative with different positions of the film 20 on the lens 10. With position of the film 20 on the lens 10 fine-tuned several times, spacing of adjustment spaces 33 is equal everywhere, and spacing of the plurality of adjustment spaces 33 is roughly same to each other, position of the film 20 on the lens 10 is more accurate, angle between the optical axis X1 of the film 20 and the first virtual connection line L1 is equal to the preset angle. In this way, it is easy to manually adjust, reduce adjustment cost, and adjustment accuracy can be reached from ±0.15 mm to ±0.05 mm, improving fitting accuracy of the film 20 on the lens 10.

In one embodiment, 0 mm≤B≤0.5 mm, B can be any of 0 mm, 0.1 mm, 0.2 mm, 0.3 mm, 0.4 mm or 0.5 mm.

In one embodiment, referring to FIG. 5, an orthographic projection of the first position surface 311 onto the lens 10 is a first virtual projection line 312, shape of the first virtual projection line 312 is an arc line, a curved line or a profiled line. An orthographic projection of the second position surface 321 onto the film 20 is a second virtual projection 322, a shape of the second virtual projection line 322 is an arc line, a curved line or a profiled line.

The first virtual projection line 312 is one boundary of orthographic projection of the adjustment space 33 onto the lens 10, the second virtual projection line 322 is other boundary of orthographic projection of the adjustment space 33 onto the lens 10. each space of the adjustment space 33 can being equal, by controlling each space between the first virtual projection line 312 and the second virtual projection line 322 equal to each other.

In one embodiment, referring to FIG. 5, the position bump 31 includes a position part 313 and an extension part 314, the extension part 314 is located outside of the position incision 32, the position part 313 is received in the position incision 32, a surface of the position part 313 facing the second position surface 321 is the first position surface 311. When fine tuning position of the film 20 on the lens 10, rotating the position bump 31 relative to the position incision 32, until the alignment part 313 is received in the position incision 32, this improving adjustment freedom of the lens 10 and improving alignment accuracy of the film 20 and the lens 10.

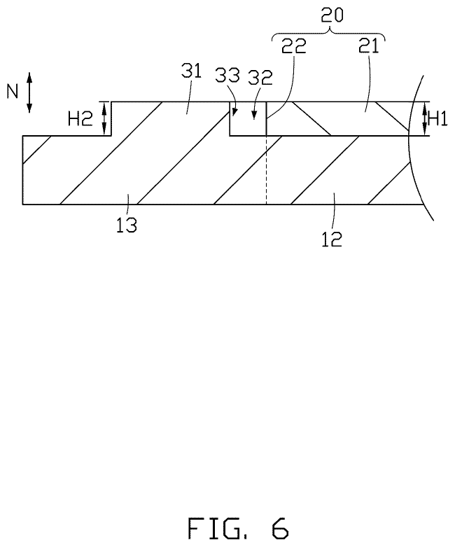

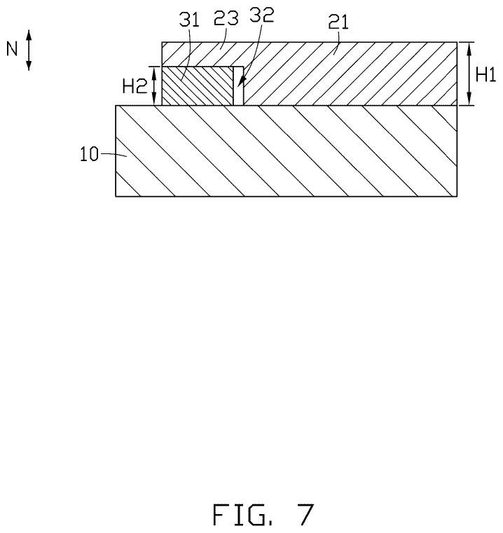

In one embodiment, referring to FIG. 6 and FIG. 7, A thickness of the film 20 is H1, a height of the position bump 31 along the thickness direction N of the lens assembly 100 is H2, H2≤H1. This avoiding the position bump 31 from extending outside of the position incision 32 along the thickness direction N, and avoiding application of the lens component 100 from being affected by the counterpoint bump 31.

In one embodiment, referring to FIG. 7, the film 20 further includes an edge part 23, the edge part 23 is connected to the cooperating part 22 away from the transparent part 21. The edge part 23 extends along a radially direction of the lens assembly 100. The edge part 23 is opposite to the position bump 31 along the thickness direction N. An orthographic projection of the edge part 23 onto the lens 10 along the thickness direction N covers the position bump 31, the edge part 23 can block the position bump 31, and improving integrality of edge side of the lens assembly 100.

In one embodiment, the edge part 23 is spaced apart from the position bump 31. In other embodiment, referring to FIG. 7, the edge part 23 is attached to surface of the position bump 31.

In one embodiment, cross section shape of the position bump 31 is round. In other embodiment, referring to FIG. 8-10, cross section shape of the position bump 31 is a polygonal shape such as a quadrilateral, triangle, or pentagon. When cross section shape of the position bump 31 is a polygonal shape, at least two sides of the polygon is extended into the position incision 32 to improve positioning reliability of the lens assembly 100.

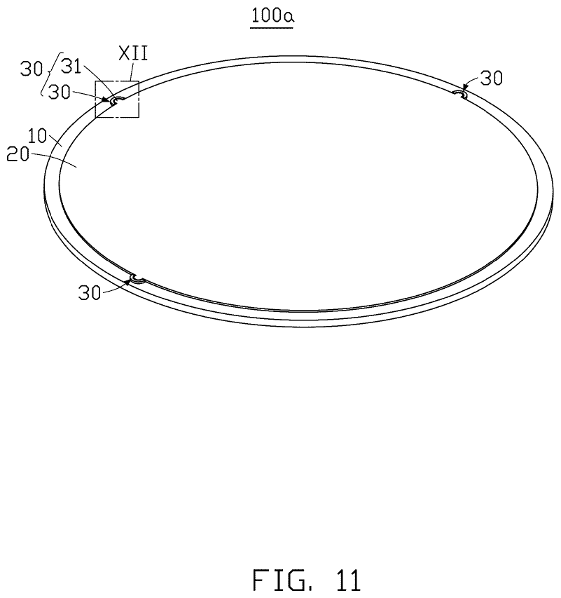

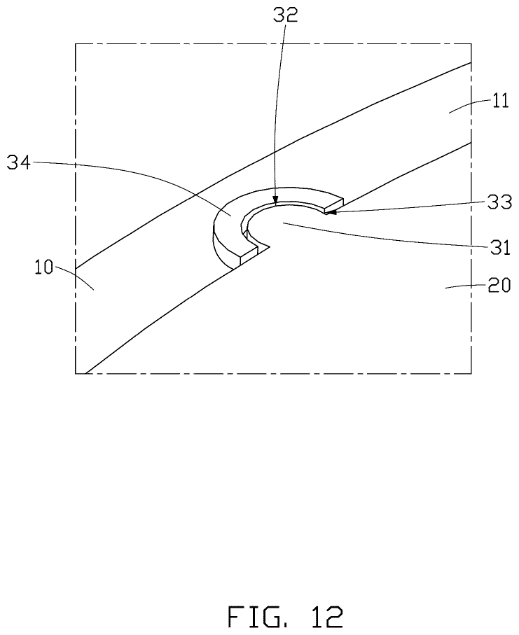

In one embodiment, referring to FIG. 11 and FIG. 12, the position bump 31 is protruded from edge of the film 20. The lens 10 further includes a plurality of positioning part 34. The positioning part 34 protrudes from the bonding surface 11. The position bump 31 is located at outside of the film 20 along radial direction of the lens assembly 100. The position incision 32 is defined at side surface of the positioning part 34, the position incision 32 penetrates the lens 10 in the thickness direction N of the lens assembly 100. The position bump 31 is received in the position incision 32. In this way, when a material strip is processed to form the film 20, retaining a portion of edge of the film 20 as the position bump 31, this reducing machining loss rate of the material strip, and reducing processing cost of the lens assembly 100.

In one embodiment, referring to FIG. 12, shape of the position incision 32 is half slot. In other embodiment, cross section shape of the position incision 32 can be polygon, special shape and other shapes.

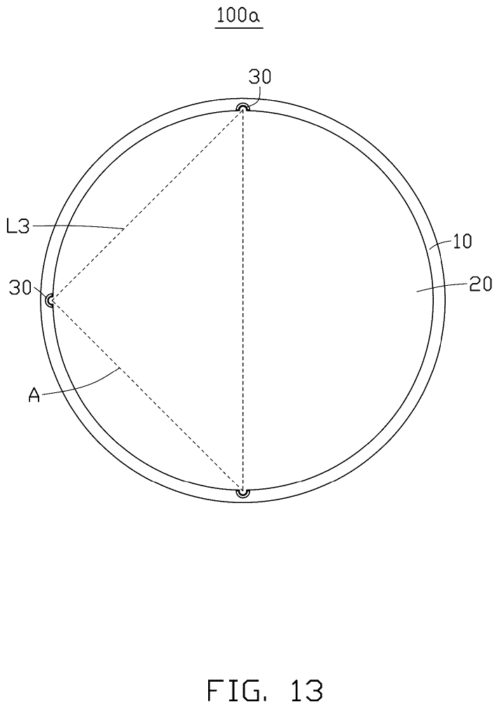

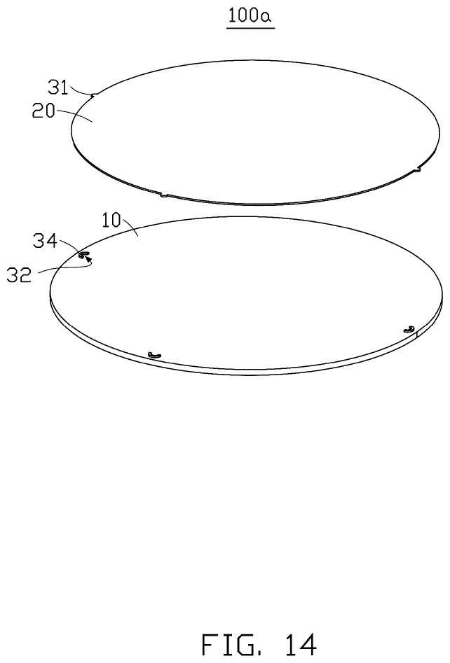

In one embodiment, referring to FIG. 13 and FIG. 14, the plurality of positioning parts 34 is located at edge of the lens 10, and is distributed at intervals along a circumference of the lens 10. Each two adjacent positioning parts 34 define one of the plurality of boundary virtual connection lines L3, the plurality of boundary virtual connection lines L3 connected and enclosed to form the polygonal region A.

The above embodiments are only used to illustrate the technical solutions of the present application and are not intended to be limiting, although the application has been described in detail with reference to the above preferred embodiments, a person of ordinary skill in the art should understand that modifications or equivalent substitutions can be made to the technical solutions of the present application without departing from the spirit and scope of the technical solutions of the present application.

What is claimed is:

1. A lens assembly comprising:
a lens having a bonding surface;
a film bonded on the bonding surface, and defining a first optical axis; and
a plurality of position structures, each of the plurality of position structures comprising a position bump and a position incision, wherein one of the position bump or the position incision is arranged on the bonding surface, another one of the position bump or the position incision is arranged at edges of the film, a part of the position bump is received in the position incision, two of the plurality of position structures defines a first virtual connection line, an angle between the first virtual connection line and the first optical axis is equal to a preset angle.

2. The lens assembly of claim 1, wherein the position bump defines a first position surface, the position incision defines a second position surface, the first position surface is spaced apart from the second position surface, and an adjustment space is defined between the first and the second position surfaces, each distances between the first position surface and the second position surface along a circumferential direction of the position incision are equal to each other.

3. The lens assembly of claim 2, wherein the position bump comprises a position part and an extension part, the extension part is located outside of the position incision, the position part is received in the position incision, a surface of the position part facing the second position surface is the first position surface.

4. The lens assembly of claim 2, wherein an orthographic projection of the first position surface onto the lens is a first virtual projection line, a shape of the first virtual projection line is an arc line, a curved line or a profiled line;
an orthographic projection of the second position surface onto the lens is a second virtual projection, a shape of the second virtual projection line is an arc line, a curved line or a profiled line.

5. The lens assembly of claim 1, wherein the position bump protrudes from the bonding surface;
the position incision is opened on an edge of the film, and the position incision penetrates the film along a thickness direction of the lens assembly.

6. The lens assembly of claim 5, wherein a thickness of the film is H1, a height of the position bump along the thickness direction of the lens assembly is H2, H2≤H1.

7. The lens assembly of claim 1, wherein the lens defines a first central point on an orthographic projection of the first optical axis onto the film; each two adjacent position structures of the plurality of position structures define a boundary virtual connection line, a polygonal region is defined by the boundary virtual connection line connected to adjacent boundary virtual connection lines, the first central point is located inside of the polygonal region or on the boundary virtual connection line.

8. The lens assembly of claim 1, wherein the film defines a second central point; the plurality of position structure comprises a first position structure and a second position structure, a first virtual connection line is defined between the first position structure and the second position structure, the first virtual connection line and the optical axis intersects at the second central point, or the first virtual connection line coincides with the optical axis.

9. The lens assembly of claim 1, wherein the lens comprises an optical part and a connection part, the connection part is connected to edges of the optical part; the film comprises a transparent part and a cooperating part, the cooperating part is connected to edges of the transparent part, the transparent part is bonded on the optical part; one of the position bump or the position incision is arranged at the connection part, another one of the position bump or the position incision is arranged at the cooperating part.

10. The lens assembly of claim 1, wherein the plurality of position structures is distributed at intervals along a circumference of the lens.

11. A display device comprising:
a mounting frame;
a lens assembly arranged in the mounting frame, the lens assembly comprising:
a lens having a bonding surface;
a film bonded on the bonding surface, and defining a first optical axis; and
a plurality of position structures, each of the plurality of position structures comprising a position bump and a position incision, wherein one of the position bump or the position incision is arranged on the bonding surface, another one of the position bump or the position incision is arranged at edges of the film, a part of the position bump is received in the position incision, two of the plurality of position structures defines a first virtual connection line, an angle between the first virtual connection line and the first optical axis is equal to a preset angle.

12. The display device of claim 11, wherein the position bump defines a first position surface, the position incision defines a second position surface, the first position surface is spaced apart from the second position surface, and an adjustment space is defined between the first and second position surfaces, each distances between the first position surface and the second position surface along a circumferential direction of the position incision are equal to each other.

13. The display device of claim 12, wherein the position bump comprises a position part and an extension part, the extension part is located outside of the position incision, the position part is received in the position incision, a surface of the position part facing the second position surface is the first position surface.

14. The display device of claim 12, wherein an orthographic projection of the first position surface onto the lens is a first virtual projection line, a shape of the first virtual projection line is an arc line, a curved line or a profiled line;
an orthographic projection of the second position surface onto the lens is a second virtual projection, a shape of the second virtual projection line is an arc line, a curved line or a profiled line.

15. The display device of claim 11, wherein the position bump protrudes from the bonding surface;
the position incision is opened on an edge of the film, and the position incision penetrates the film along a thickness direction of the lens assembly.

16. The display device of claim 15, wherein a thickness of the film is H1, a height of the position bump along the thickness direction of the lens assembly is H2, H2≤H1.

17. The display device of claim 11, wherein the lens defines a first central point on an orthographic projection of the first optical axis onto the film; each two adjacent position structures of the plurality of position structures define a boundary virtual connection line, a polygonal region is defined by the boundary virtual connection line connected to adjacent boundary virtual connection lines, the first central point is located inside of the polygonal region or on the boundary virtual connection line.

18. The display device of claim 11, wherein the film defines a second central point; the plurality of position structure comprises a first position structure and a second position structure, a first virtual connection line is defined between the first position structure and the second position structure, the first virtual connection line and the optical axis intersects at the second central point, or the first virtual connection line coincides with the optical axis.

19. The display device of claim 11, wherein the lens comprises an optical part and a connection part, the connection part is connected to edges of the optical part; the film comprises a transparent part and a cooperating part, the cooperating part is connected to edges of the transparent part, the transparent part is bonded on the optical part; one of the position bump or the position incision is arranged at the connection part, another one of the position bump or the position incision is arranged at the cooperating part.

20. The display device of claim 11, wherein the plurality of position structures is distributed at intervals along a circumference of the lens.
